(19) United States
(12) Patent Application Publication
(10) Pub. No.: US 2016/0352602 A1
(43) Pub. Date: Dec. 1, 2016

(54) COMMUNICATION APPARATUS, COMMUNICATION METHOD, AND STORAGE MEDIUM

(71) Applicant: CANON KABUSHIKI KAISHA, Tokyo (JP)

(72) Inventor: Yukio Numakami, Kawasaki-shi (JP)

(21) Appl. No.: 15/149,554

(22) Filed: May 9, 2016

(30) Foreign Application Priority Data
May 25, 2015 (JP) 2015-105893

(51) Int. Cl. H04L 12/26; H04L 29/08

(52) U.S. Cl. CPC H04L 43/0823; H04L 67/02; H04L 43/0811; H04L 67/143

(57) ABSTRACT

A communication apparatus includes a communication unit configured to perform a communication with a different communication apparatus using one or more second logical connections established based on a first logical connection established between the communication apparatus and the different communication apparatus, a detection unit configured to detect an error caused by a second logical connection used by the communication unit on the basis of a content of data that the communication unit has received when communicating with the different communication apparatus, and a termination unit configured to terminate, if the detection unit detects an error caused by the second logical connection, the first logical connection on the basis of a communication status between the communication apparatus and the different communication apparatus.

### BACKGROUND OF THE INVENTION

Field of the Invention

The present invention relates to a communication method for performing a communication using logical connections.

Description of the Related Art

A Hyper Text Transfer Protocol (HTTP) is one of the protocols (communication protocols) widely used as an Internet standard technique. As a new version of HTTP, HTTP/2 has been developed and standardized by an Internet standardizing organization called the Internet Engineering Task Force (IETF). In an HTTP/2 communication, a logical connection called a stream is used. Communication apparatuses capable of performing an HTTP/2 communication can establish a plurality of streams (second logical connections) that is based on a connection (a first logical connection) established therebetween. The communication apparatuses perform a communication by an independent sequence in each of the streams.

According to a technique discussed in Japanese Patent No. 5452602, on the basis of a history of errors that have occurred during a connection, an amount of data that a communication apparatus transmits between establishment and termination of the connection is determined. In this way, a decrease in data transmitting efficiency that is attributable to halt of the connection is prevented.

With the conventional technique, when an error is caused by a second logical connection established based on the first logical connection, depending on the circumstances, heavy processing load is placed on error handling performed by the communication apparatus. For example, in an HTTP/2 communication, if a plurality of streams based on the same connection causes errors and if the communication apparatus performs processing such as notification of the errors caused by the respective streams while maintaining the connection, the processing load on the communication apparatus is increased.

### SUMMARY OF THE INVENTION

According to an aspect of the present invention, there is provided a communication apparatus including a communication unit configured to perform a communication with a different communication apparatus using one or more second logical connections established based on a first logical connection established between the communication apparatus and the different communication apparatus, a detection unit configured to detect an error caused by a second logical connection used by the communication unit on the basis of a content of data that the communication unit has received when communicating with the different communication apparatus, and a termination unit configured to terminate, if the detection unit has detected an error caused by the second logical connection, the first logical connection on the basis of a communication status between the communication apparatus and the different communication apparatus.

Further features of the present invention will become apparent from the following description of exemplary embodiments with reference to the attached drawings.

### BRIEF DESCRIPTION OF THE DRAWINGS

FIG. 1 illustrates a configuration of a communication system according to an exemplary embodiment.

FIG. 2 illustrates a hardware configuration of a second communication apparatus according to the exemplary embodiment.

FIG. 3 is a block diagram illustrating a configuration of function modules of the second communication apparatus according to the exemplary embodiment.

FIG. 4 is a sequence diagram illustrating processing performed by first and second communication apparatuses from a start to an end of an HTTP communication according to a first exemplary embodiment.

FIG. 5 is a sequence diagram illustrating processing relating to connection of the HTTP communication between the first and second communication apparatuses according to the exemplary embodiment.

FIG. 6 is a flowchart illustrating processing, by the second communication apparatus according to the first exemplary embodiment, relating to determination of whether to handle a stream error as a connection error (connection error determination processing).

FIG. 7 is a flowchart illustrating processing, by the second communication apparatus according to the first exemplary embodiment, relating to determination of the cause of a stream error.

FIG. 8 is a flowchart illustrating processing, by the second communication apparatus according to the first exemplary embodiment, for determining whether an active stream based on a connection exists.

FIG. 9 is a sequence diagram illustrating processing performed by first and second communication apparatuses from a start to an end of an HTTP communication according to a second exemplary embodiment.

### DESCRIPTION OF THE EMBODIMENTS

Hereinafter, exemplary embodiments of the present invention will be described with reference to the drawings. The present invention according to the scope of the claims is not limited to the following exemplary embodiments. In addition, all of the combinations of features described in the following exemplary embodiments are not necessarily required to realize the present invention.

### [System Configuration]

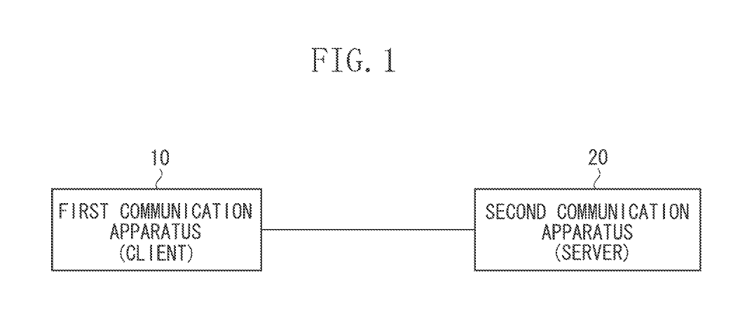

FIG. 1 illustrates a configuration of a communication system according to an exemplary embodiment. The communication system includes a first communication apparatus 10 (hereinafter, referred to as a communication apparatus 10) and a second communication apparatus 20 (hereinafter, referred to as a communication apparatus 20). These communication apparatuses are connected by a wireless local area network (LAN) based on IEEE 802.11.

The communication apparatus 10 serves as a client and the communication apparatus 20 serves as a server. Examples of the communication apparatuses 10 and 20 include a digital camera, a digital video camera, a network camera, a printer, a digital multifunction peripheral, a digital television, a projector, a mobile phone, a smartphone, a personal computer (PC), and a server apparatus. For example, if the communication apparatus 10 is a PC and the communication apparatus 20 is a network camera, a user operates the PC and requests the network camera to transmit a captured image. The network camera that has received the request transmits the captured image to the PC, and the PC displays the received image on a display.

The present exemplary embodiment will be described assuming that the communication apparatuses 10 and 20 directly connect to each other on the wireless LAN. However, the communication apparatuses 10 and 20 may connect to each other via a wireless access point. The communication apparatuses 10 and 20 may use a different wireless communication function such as Bluetooth®, ZigBee®, or a radio-frequency identification tag (RFID), in place of a wireless LAN communication function. In addition, for example, a wired LAN communication function such as Ethernet®, or a combination of wireless and wired LAN communication functions may be used. If a wired LAN is used to establish a connection, the connection may be established via a relay apparatus such as a network switch or a router, for example. Further, as the communication apparatuses 10 and 20 are connected to each other on the same LAN in the present exemplary embodiment, the present invention is not limited to such example. For example, the communication apparatuses 10 and 20 may be connected via a wide area network (WAN), the Internet, or a public telephone line.

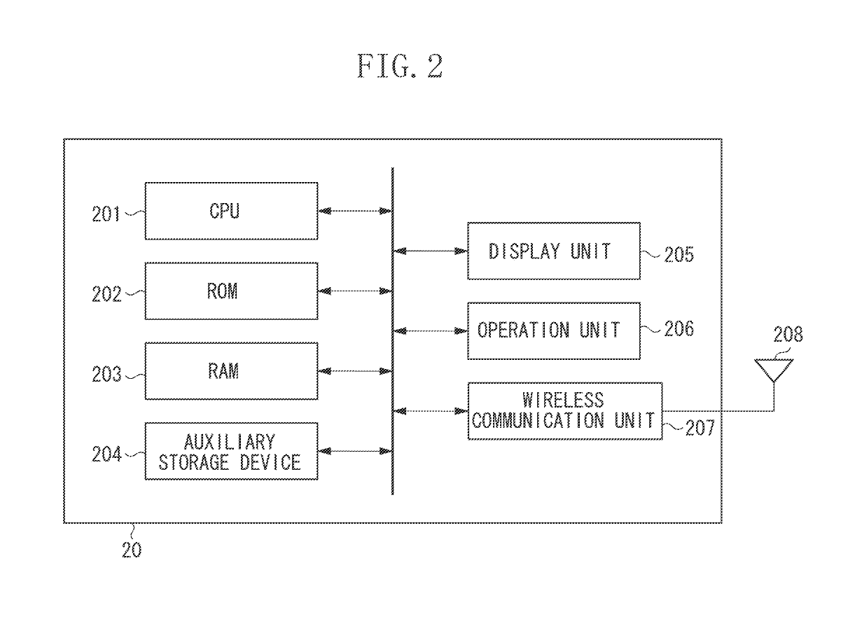

Now, elements included in these communication apparatuses will be described in detail. FIG. 2 is a block diagram illustrating a hardware configuration of the communication apparatus 20 (server). The communication apparatus 10 (client) is configured in the same way as the communication apparatus 20. The communication apparatus 20 includes a central processing unit (CPU) 201, a read-only memory (ROM) 202, a random access memory (RAM) 203, an auxiliary storage device 204, a display unit 205, an operation unit 206, a wireless communication unit 207, and an antenna 208.

The CPU 201 comprehensively controls the second communication apparatus 20. The ROM 202 stores programs and parameters unnecessary to be changed. The RAM 203 temporarily stores programs and data provided by, for example, the auxiliary storage device 204. The auxiliary storage device 204 stores content data such as still images and moving images. The display unit 205 displays a graphical user interface (GUI) used by the user to operate the communication apparatus 20. The operation unit 206 is an input interface used by the user to operate the communication apparatus 20. The wireless communication unit 207 controls the antenna 208 to perform a wireless LAN communication with the communication apparatus 10. If the communication apparatuses 10 and 20 connect to each other via an external wireless access point, the wireless communication unit 207 controls the antenna 208 to perform a wireless LAN communication with the wireless access point (not illustrated). In the present exemplary embodiment, the display unit 205 and the operation unit 206 are included the communication apparatus 20. However, at least one of the display unit 205 and the operation unit 206 may exist as an independent apparatus outside the communication apparatus 20.

### [Configuration of Function Modules]

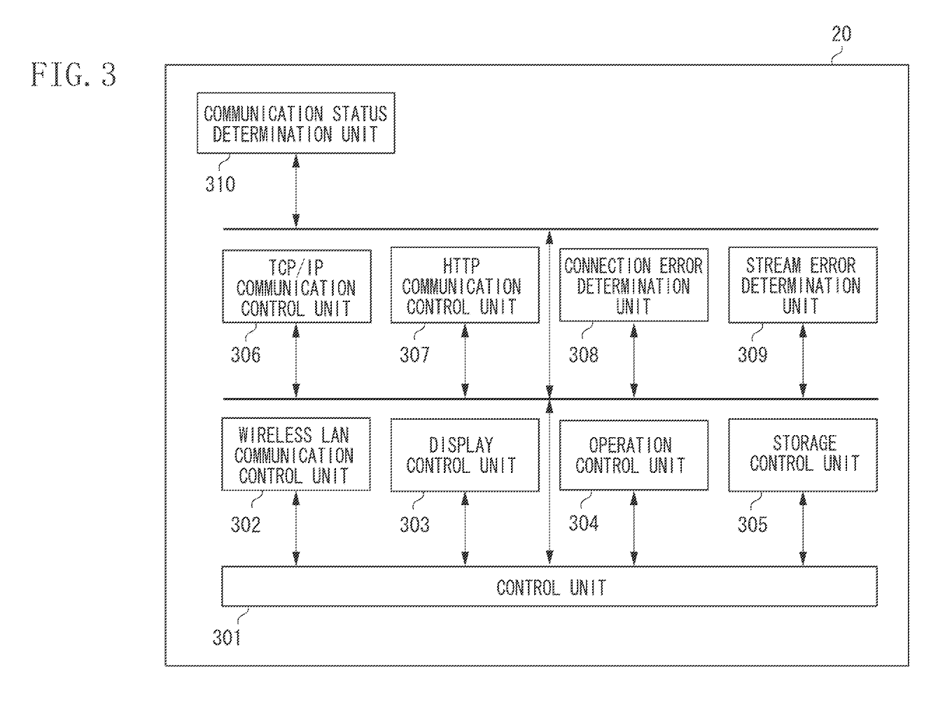

FIG. 3 is a block diagram illustrating a configuration of function modules of the communication apparatus 20 (server). The communication apparatus 10 (client) is configured in the same way as the communication apparatus 20. The communication apparatus 20 includes a control unit 301, a wireless LAN communication control unit 302 (hereinafter, referred to as a wireless control unit 302), a display control unit 303, an operation control unit 304, and a storage control unit 305. The communication apparatus 20 also includes a transmission control protocol (TCP)/Internet protocol (IP) communication control unit 306 (hereinafter, referred to as a TCP control unit 306) and a Hyper Text Transfer Protocol (HTTP) communication control unit 307 (hereinafter, referred to as an HTTP control unit 307). The communication apparatus 20 further includes a connection error determination unit 308 (hereinafter, referred to as a connection determination unit 308), a stream error determination unit 309 (hereinafter, referred to as a stream determination unit 309), and a communication status determination unit 310 (hereinafter, referred to as a communication determination unit 310). Each of these modules is realized when the CPU 201 expands a program stored in the ROM 202 on the RAM 203 and performs processing according to a flowchart that will be described below. In addition, for example, if hardware processing is performed in place of software processing using the CPU 201, a calculation unit and a circuit that correspond to the following processing performed by the above modules may be configured. The communication apparatus 20 does not need to include all the above modules.

The control unit 301 controls each of the function modules included in the communication apparatus 20. The wireless control unit 302 controls the wireless communication unit 207 to control a wireless LAN communication with the communication apparatus 10. If the communication apparatuses 10 and 20 connect to each other via an external wireless access point, the wireless control unit 302 controls the wireless communication unit 207 to control a wireless LAN communication with the wireless access point (not illustrated). The display control unit 303 controls what is displayed on the GUI of the communication apparatus 20 by controlling the display unit 205. The operation control unit 304 controls the operation unit 206 to control instructions that are input from the user to the communication apparatus 20. The storage control unit 305 controls the RAM 203 and the auxiliary storage device 204 to store or delete processing data or content data such as still images and moving images.

The TCP control unit 306 uses the wireless control unit 302 to control a TCP/IP communication with the communication apparatus 10. In the present exemplary embodiment, a TCP/IP communication is used. However, a communication based on a different protocol such as a user datagram protocol (UDP) may be used. The HTTP control unit 307 uses the TCP control unit 306 to control an HTTP/2 communication with the communication apparatus 10. The HTTP control unit 307 is also capable of controlling an HTTP security (HTTPS) communication using transport layer security (TLS) with the communication apparatus 10. However, the HTTP control unit 307 may perform communication control based on a communication technique other than the above techniques (for example, SPDY).

When an HTTP/2 communication is performed, a logical connection called a stream is used. Communication apparatuses capable of performing an HTTP/2 communication can establish a plurality of streams (second logical connections) that is based on a connection (a first logical connection) in the transport layer between the communication apparatuses. The communication apparatuses perform a communication by an independent sequence in each of the streams. In addition, the communication apparatuses can establish a plurality of connections and establish a plurality of streams per connection.

If a stream (a second connection) causes an error, the connection determination unit 308 determines whether to handle the error as a connection error using the stream determination unit 309 and the communication determination unit 310. The connection error is an error relating to a connection status, and affects all the communications using the streams based on the connection. In contrast, a stream error is an error relating to a specific stream, and does not affect processing on other streams. If a connection error occurs, the HTTP control unit 307 transmits a GOAWAY frame defined in HTTP/2 to the communication apparatus 10 to disconnect the connection (the first connection). In this way, the HTTP control unit 307 performs processing for terminating the connection (the first connection). The GOAWAY frame defined in HTTP/2 is information indicating that the communication apparatus does not establish a new stream based on the connection used in the transmission of the GOAWAY frame.

Whether to handle the error as a connection error is determined based on, for example, the communication status between the communication apparatuses 20 and 10 when the stream error occurs. For example, the communication status between the communication apparatuses 20 and 10 used for making the above determination includes at least one of: the number of stream errors detected by the stream determination unit 309; the number of streams (second connections) based on a target connection (a first connection); and the content of data that the HTTP control unit 307 is transmitting using the stream. All of the above information or other information may be used for determining whether to handle a stream error as a connection error. In the present exemplary embodiment, the number of detected errors is, for example, the number of stream errors detected in the same connection, the number of detected errors caused by the same stream, or the number of stream errors detected within a predetermined period of time. The number of streams based on a target connection is, for example, the number of streams that have been established or reserved based on the target connection as a connection error determination target. The content of data is, for example, a type of the content that the data constitutes, an amount of the data, or a display size if the content is a still image or a moving image. The connection determination unit 308 does not need to use all the above criteria when performing the above determination processing. The connection determination unit 308 may use at least one of the above criteria when performing the above determination processing.

On the basis of the content of the data that the HTTP control unit 307 receives through a communication with the communication apparatus 10, the stream determination unit 309 detects an error caused by the corresponding stream (second connection) used for the HTTP communication with the communication apparatus 10. The stream determination unit 309 counts the number of detected stream errors depending on the cause of the stream error. In the present exemplary embodiment, the stream determination unit 309 counts the number of detected stream errors per cause of the stream error. However, the stream determination unit 309 may count the number of stream errors on a different basis. The stream determination unit 309 may classify the causes of the stream errors into categories and count the number of stream errors per category. Alternatively, the stream determination unit 309 may only count the number of errors that have occurred due to a specific cause. Alternatively, the stream determination unit 309 may count the number of all the detected stream errors regardless of the cause. After the connection is terminated, the stream determination unit 309 initializes the number of stream error detection count. The communication determination unit 310 uses the HTTP control unit 307 to determine the communication status of an HTTP communication with the communication apparatus 10. In the present exemplary embodiment, the communication determination unit 310 checks execution statuses of a plurality of streams being used in HTTP communications with the communication apparatus 10.

### [Communication Sequence]

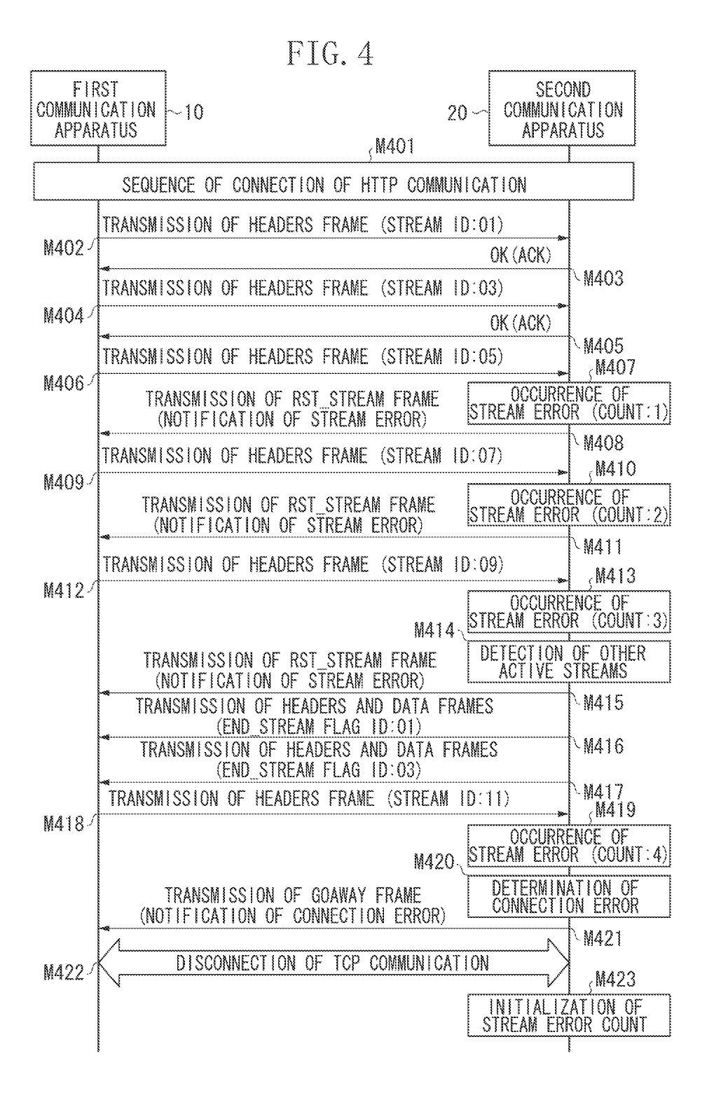

A communication sequence performed between the communication apparatuses 10 and 20 according to the present exemplary embodiment will be described in detail. FIG. 4 is a sequence diagram illustrating processing performed by the communication apparatuses 10 and 20 from a start to an end of an HTTP communication according to the present exemplary embodiment. The processing in FIG. 4 starts when a user inputs an instruction for acquiring a content from the communication apparatus 20 to the communication apparatus 10. However, the processing in FIG. 4 may start at a different timing.

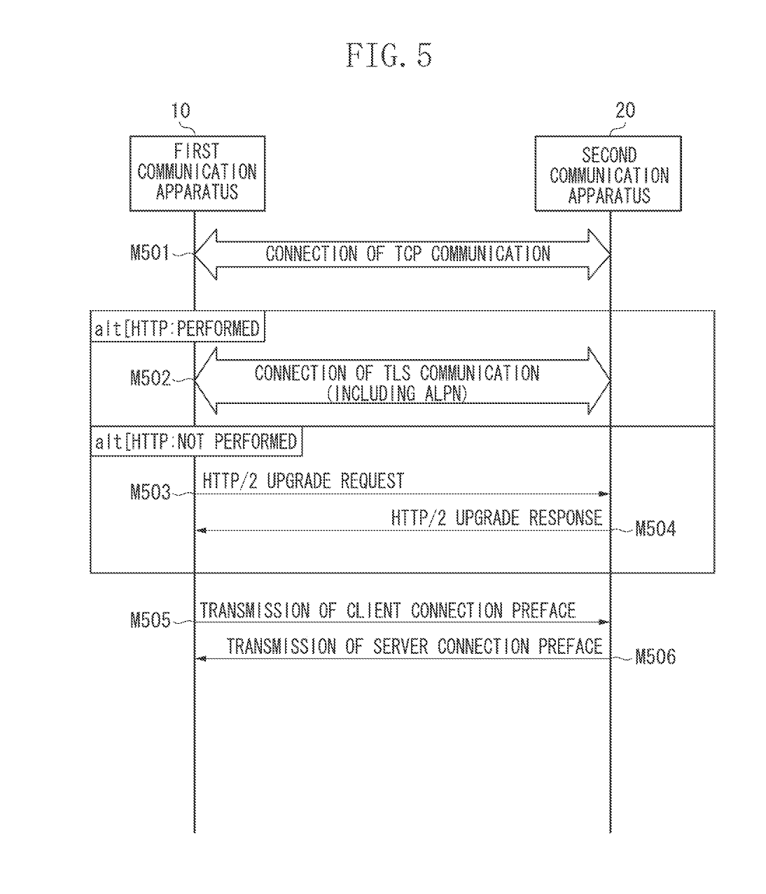

In M401, the communication apparatus 10 establishes connection of an HTTP communication with the communication apparatus 20. A detailed sequence of this connection will be described below with reference to FIG. 5. In M402, the communication apparatus 10 transmits a HEADERS frame in which HTTP request header information is written to the communication apparatus 20. In this sequence, the HTTP request uses a GET method. By transmitting the HEADERS frame, the communication apparatus 10 requests the communication apparatus 20 to establish a new stream whose stream identification (ID) is 1. In the present exemplary embodiment, the communication apparatus 10 uses a HEADERS frame specifying the GET method as described above when transmitting a request to the communication apparatus 20. However, the request method is not limited to such example. For example, the communication apparatus 10 may use a different HTTP request method such as POST or PUT or a different frame such as PUSH_PROMISE.

In M403, the HTTP control unit 307 in the communication apparatus 20 transmits a TCP ACK as a response to the HEADERS frame received in M402. In this way, a stream that is based on the connection between the communication apparatuses 10 and 20 and whose stream ID is 1 is established. Subsequently, the HTTP control unit 307 performs a communication using this stream.

In M404, as in M402, the communication apparatus 10 transmits a HEADERS frame specifying an HTTP GET method to the communication apparatus 20. In M404, the communication apparatus 10 requests the communication apparatus 20 to establish a new stream whose ID is 3. In M405, the HTTP control unit 307 in the communication apparatus 20 transmits a TCP ACK as a response to the HEADERS frame received in M404. In this way, a stream whose stream ID is 3 is established. In M406, as in M402, the communication apparatus 10 transmits a HEADERS frame specifying the HTTP GET method to the communication apparatus 20. In M406, the communication apparatus 10 requests the communication apparatus 20 to establish a new stream whose ID is 5.

In M407, the communication apparatus 20 fails to accept the request for establishing the new stream due to its insufficient memory resource or the like, and as a result, a stream error occurs. In M407, the stream determination unit 309 in the communication apparatus 20 detects the stream error and increments the number of detected stream errors by 1 (count: 1). In the present exemplary embodiment, if the stream determination unit 309 detects three or more stream errors that have occurred due to the same cause and if there are not any other active streams, the connection determination unit 308 determines to perform processing assuming that a connection error has occurred. The other active streams in the present exemplary embodiment are streams that have been established between the communication apparatuses 10 and 20, and that are other than the stream that has caused the stream error. However, the other active streams are not limited to such streams. Examples of such active streams may include streams that have been reserved by PUSH_PROMISE. Accordingly, occurrence of a connection error may be determined in a different manner.

In M408, the HTTP control unit 307 in the communication apparatus 20 transmits a RST_STREAM frame that indicates the stream error to the communication apparatus 10. In addition, in the present exemplary embodiment, REFUSED_STREAM is specified as an error code in the RST_STREAM frame. However, the error code is not limited to REFUSED_STREAM. A different error code may be used. In HTTP/2, if a RST_STREAM frame is transmitted, the connection of the corresponding stream terminates. After the stream terminates, the communication apparatuses 10 and 20 are no longer capable of communicating with each other using the stream again.

In M409, as in M402, the communication apparatus 10 transmits a HEADERS frame specifying the HTTP GET method to the communication apparatus 20. In M409, the communication apparatus 10 requests the communication apparatus 20 to establish a new stream whose ID is 7. In M410, a stream error occurs due to the same cause as that in M407. In M410, as in M407, the stream determination unit 309 in the communication apparatus 20 detects the stream error and increments the number of detected stream errors by 1 (count: 2). In M411, as in M408, the HTTP control unit 307 in the communication apparatus 20 transmits a RST_STREAM frame to the communication apparatus 10. In M412, as in M402, the communication apparatus 10 transmits a HEADERS frame specifying the HTTP GET method to the communication apparatus 20. In M412, the communication apparatus 10 requests the communication apparatus 20 to establish a new stream whose ID is 9.

In M413, a stream error occurs due to the same cause as that in M407. In M413, as in M407, the stream determination unit 309 in the communication apparatus 20 detects the stream error and increments the number of detected stream errors by 1 (count: 3). In M414, the number of detected stream errors due to the same cause has reached 3. However, since there are other active streams, the connection determination unit 308 in the communication apparatus 20 determines not to handle this stream error as a connection error. The other active streams in M414 are the streams that have been newly established in M403 and M405 (stream IDs: 1 and 3, respectively). If there are other active streams, the connection determination unit 308 according to the present exemplary embodiment does not handle a stream error as a connection error. However, the present invention is not limited to such example. For example, if at least a predetermined number of stream errors are detected, the connection determination unit 308 may handle the last stream error as a connection error even if there are other active streams. In M415, as in M408, the HTTP control unit 307 in the communication apparatus 20 transmits a RST_STREAM frame to the communication apparatus 10.

In M416, the HTTP control unit 307 in the communication apparatus 20 transmits a HEADERS frame and a DATA frame as an HTTP response, respectively, to the request made in M402. In the present exemplary embodiment, an END_STREAM flag is set in the DATA frame. Therefore, when the communication of the DATA frame terminates, the stream whose stream ID is 1 terminates. In M417, the HTTP control unit 307 in the communication apparatus 20 transmits a HEADERS frame and a DATA frame as an HTTP response, respectively, to the request made in M404. In the present exemplary embodiment, an END_STREAM flag is also set in the DATA frame. Therefore, when the communication of the DATA frame terminates, the stream whose stream ID is 3 terminates.

In M418, as in M402, the communication apparatus 10 transmits a HEADERS frame specifying the HTTP GET method to the communication apparatus 20. In M418, the communication apparatus 10 requests the communication apparatus 20 to establish a new stream whose ID is 11. In M419, a stream error occurs due to the same cause as that in M407. In M419, as in M407, the stream determination unit 309 in the communication apparatus 20 detects the stream error and increments the number of detected stream errors by 1 (count: 4).

In M420, the number of detected stream errors due to the same cause has reached 4. In addition, there are not any other active streams. Therefore, the connection determination unit 308 in the communication apparatus 20 determines to handle this stream error as a connection error. In M421, the HTTP control unit 307 in the communication apparatus 20 transmits a GOAWAY frame that indicates a connection error to the communication apparatus 10. In M422, the communication apparatuses 10 and 20 terminate the HTTP communication. More specifically, the communication apparatuses 10 and 20 disconnect a TCP connection. In M423, the stream determination unit 309 in the communication apparatus 20 initializes the number of stream error detection count (count: 0).

### [Sequence of Connection of HTTP Communication]

FIG. 5 is a sequence diagram illustrating processing relating to connection of the HTTP communication between the communication apparatuses 10 and 20. FIG. 5 illustrates the processing in M401 in FIG. 4 in detail.

In M501, the communication apparatus 10 establishes a TCP connection with the communication apparatus 20. If an HTTPS communication is performed, the processing proceeds to M502. In M502, the communication apparatus 10 establishes a connection of a transport layer security (TLS) communication with the communication apparatus 20. When establishing a connection of the TLS communication, negotiations for a HTTP/2 communication are also performed by application layer protocol negotiation (ALPN). If an HTTPS communication is not performed, the processing proceeds to M503. In M503, the communication apparatus 10 transmits an HTTP/2 upgrade request to the communication apparatus 20. In M504, in response to the request, the HTTP control unit 307 in the communication apparatus 20 transmits an HTTP/2 upgrade response to the communication apparatus 10. After M502 or M504, the HTTP/2 communication is performed between the communication apparatuses 10 and 20.

In M505, the communication apparatus 10 transmits a client connection preface to the communication apparatus 20. The connection preface includes a SETTINGS frame and uses a Primary Rate Interface (PRI) method. In M506, the HTTP control unit 307 in the communication apparatus 20 transmits a server connection preface to the communication apparatus 10. The server connection preface consists of a potentially empty SETTINGS frame.

### [Flow of Connection Error Determination Processing]

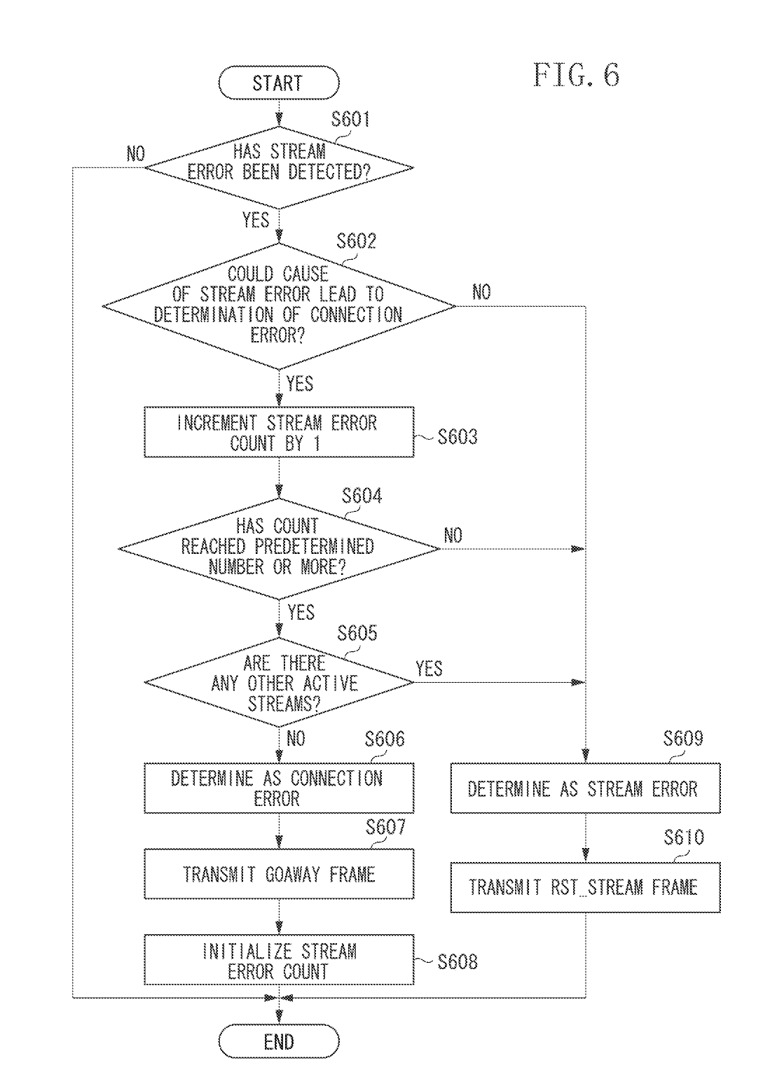

FIG. 6 is a flowchart illustrating processing relating to determination of whether to handle a stream error as a connection error (connection error determination processing), the processing performed by the second communication apparatus 20. The processing in FIG. 6 starts when the communication apparatus 20 transmits or receives a HEADERS frame to or from the communication apparatus 10. This processing is performed on each of the streams whose IDs are different. However, the processing in FIG. 6 may start at a different timing.

In step S601, the stream determination unit 309 determines whether a stream error has been detected during an HTTP communication with the communication apparatus 10. If the stream determination unit 309 has detected a stream error (Yes in step S601), the processing proceeds to step S602. If not (No in step S601), the communication apparatus 20 ends the processing. In the present exemplary embodiment, stream errors occur in the following cases. For example, a stream error occurs when a communication that is not compliant with the specifications of HTTP/2 is performed. For example, if the communication apparatus 20 receives requests (HEADERS frames) for establishing more than a predetermined number (first predetermined number) of streams, a stream error occurs. The first predetermined number is, for example, the number of streams that can be established. The communication apparatus 20 notifies the communication apparatus 10 of this number by transmitting a SETTINGS frame. A stream error also occurs when the content of a control frame or a data frame transmitted from the communication apparatus 10 is not accepted by the communication apparatus 20 even when the content is compliant with the specifications of HTTP/2. For example, when the communication apparatus 20 performs high-load processing and temporality has a limited resource therein, there are cases in which the communication apparatus 20 cannot accept any new streams. In such cases, a stream error occurs. In addition, after the communication apparatus 20 transmits a SETTINGS frame indicating an initial window size to decrease the size of a flow control window, if the communication apparatus 20 receives a DATA frame whose data amount exceeds the initial window size, a stream error also occurs.

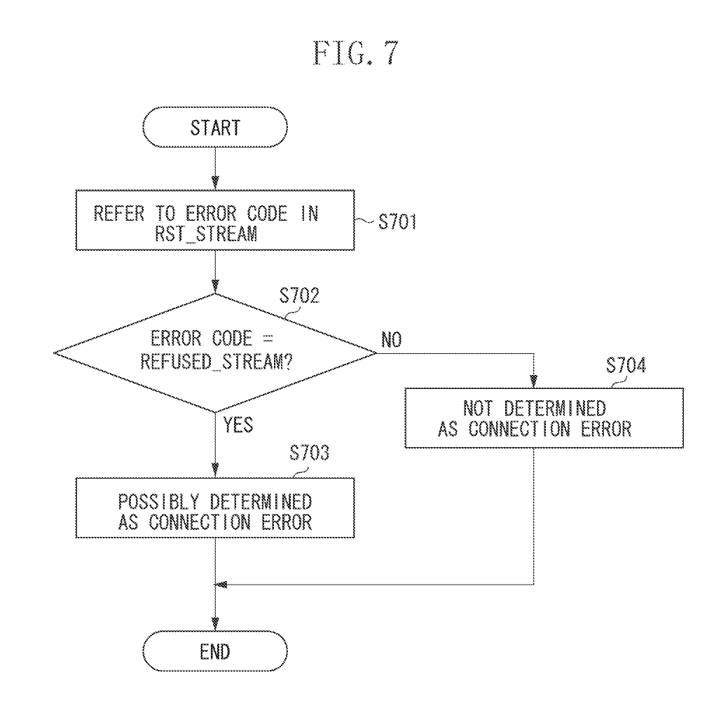

In step S602, the stream determination unit 309 determines whether the cause of the stream error detected in step S601 could lead to determination of a connection error. The processing in step S602 will be described in detail below with reference to FIG. 7. If the cause of the stream error could lead to determination of a connection error (Yes in step S602), the processing proceeds to step S603. If not (No in step S602), the processing proceeds to step S609. In the present exemplary embodiment, the stream determination unit 309 determines whether to count the stream errors depending on the cause of the stream error. However, the stream determination unit 309 may count all the stream errors that have been detected.

In step S603, the stream determination unit 309 increments the number of detected stream errors by 1 on the basis of the cause of the detected stream error. In the present exemplary embodiment, the stream determination unit 309 counts the detected stream errors caused by streams (second logical connections) based on a connection (first logical connection) per cause. However, the detected stream errors may be counted differently. The stream determination unit 309 may classify the causes of the stream errors into categories and count the detected stream errors per category. The stream determination unit 309 may count only the errors that have occurred due to a specific cause. Alternatively, the stream determination unit 309 may count all the detected stream errors regardless of the cause. In step S604, the connection determination unit 308 determines whether the number of stream errors (stream errors that could result in connection errors) counted by the stream determination unit 309 has reached a predetermined number or more. If the connection determination unit 308 determines that the number of stream errors has reached the predetermined number or more (Yes in step S604), the processing proceeds to step S605. If not (No in step S604), the processing proceeds to step S609.

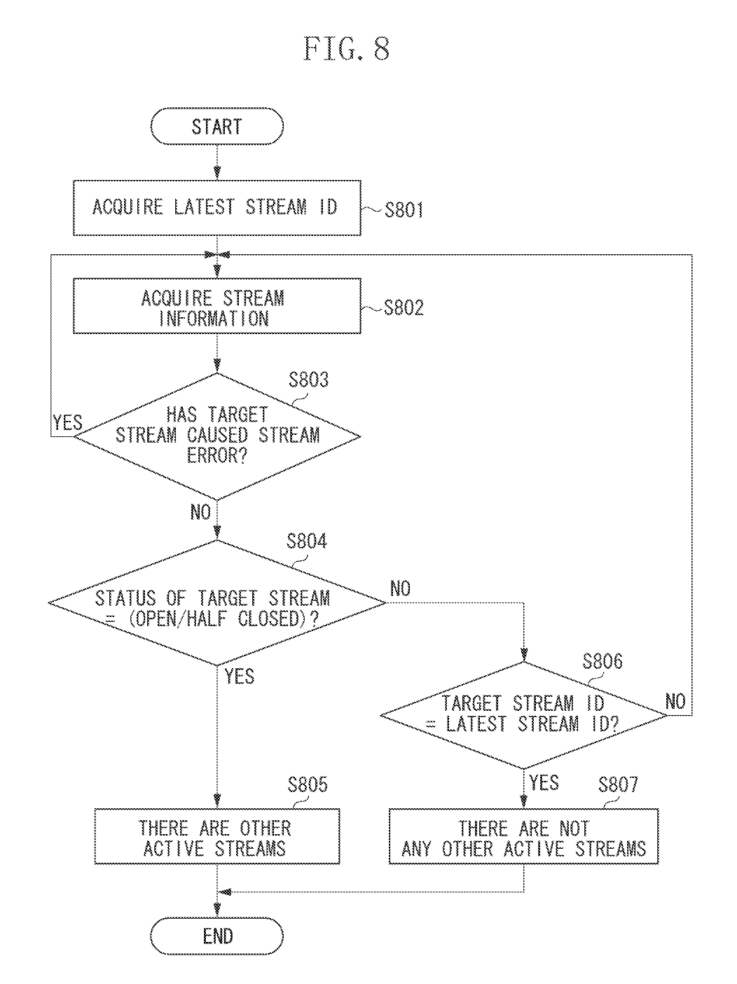

In step S605, the communication determination unit 310 determines whether there are any active and valid streams other than the stream that has caused the stream error detected in step S601 in the HTTP communication with the communication apparatus 10. The processing in step S605 will be described in detail below with reference to FIG. 8. If the communication determination unit 310 determines that there are not any other active and valid streams (No in step S605), the processing proceeds to step S606. Otherwise (Yes in step S605), the processing proceeds to step S609.

In step S606, the connection determination unit 308 determines to handle the stream error as a connection error, and determines an error code to be included in a GOAWAY frame that is to be transmitted to the communication apparatus 10 in step S607. In the present exemplary embodiment, the connection determination unit 308 uses a PROTOCOL_ERROR that indicates an unspecified error as the error code to be included in the GOAWAY frame. However, a different error code may be used. In addition, debug information indicating that the stream error is to be handled as a connection error and the reason therefor may be included in additional debug information in the GOAWAY frame.

In step S607, the HTTP control unit 307 transmits the GOAWAY frame including the error code determined in step S606 and the additional debug information to the communication apparatus 10, and disconnects the connection. Namely, the HTTP control unit 307 terminates the connection (first connection). Alternatively, the HTTP control unit 307 may terminate the connection without transmitting the GOAWAY frame, or may terminate the connection in a different manner. The HTTP control unit 307 may continue the communication after transmitting the GOAWAY frame. In step S608, the stream determination unit 309 initializes the number of stream error detection count, and ends the processing.

In step S609, the connection determination unit 308 determines not to handle the stream error as a connection error. In addition, the connection determination unit 308 determines an error code to be included in a RST_STREAM frame that is to be transmitted to the communication apparatus 10 in step S610 on the basis of the cause of the error determined by the stream determination unit 309. In step S610, the HTTP control unit 307 transmits the RST_STREAM frame including the error code determined in step S609 to the communication apparatus 10, and ends the processing.

### [Flow of Stream Error Cause Determination Processing]

FIG. 7 is a flowchart illustrating processing relating to determination of the cause of a stream error, the processing being performed by the communication apparatus 20. FIG. 7 illustrates the processing performed in step S602 in FIG. 6 in detail.

In step S701, the stream determination unit 309 checks the cause of the stream error detected in step S601. More specifically, the stream determination unit 309 refers to an error code that corresponds to the detected stream error, the error code being included in a RST_STREAM frame to be transmitted by the communication apparatus 20 or a RST_STREAM that the communication apparatus 20 has received from the communication apparatus 10. In step S702, the stream determination unit 309 determines whether the error code to which the stream determination unit 309 has referred in step S701 is REFUSED_STREAM. If the error code is REFUSED_STREAM (Yes in step S702), the processing proceeds to step S703. If not (No in step S702), the processing proceeds to step S704. In the present exemplary embodiment, only the stream error whose error code is REFUSED_STREAM leads to determination of whether to handle the stream error as a connection error (the connection error determination processing). However, a stream error that has a different error code may lead to the connection error determination processing. For example, all the stream errors whose error code is neither NO_ERROR nor CANCEL may lead to the connection error determination processing. For another example, stream errors may be counted per type by classifying stream errors whose error code is INTERNAL_ERROR and stream errors whose error code is PROTOCOL_ERROR into a first type, and streams errors whose error code is REFUSED_STREAM into a second type.

In step S703, the stream determination unit 309 determines that the cause of the steam error leads to the connection error determination processing, and ends the processing in FIG. 7. Then, the processing proceeds to step S603 in FIG. 6. In step S704, the stream determination unit 309 determines that the cause of the stream error does not lead to the connection error determination processing, and ends the processing in FIG. 7. Then, the processing proceeds to step S609 in FIG. 6.

In the present exemplary embodiment, the connection determination unit 308 determines whether a stream error leads to the connection error determination processing on the basis of the corresponding error code. However, the present invention is not limited to such example. For example, the connection determination unit 308 may perform the connection error determination processing on the basis of a content of a frame indicating the cause of a stream error and transmitted from the communication apparatus 10. Alternatively, regardless of the cause, all stream errors may lead to the connection error determination processing.

### [Flow for Determining Whether any Active Streams Exist]

FIG. 8 is a flowchart illustrating processing for determining whether an active stream based on a connection exists, the processing being performed by the communication apparatus 20. FIG. 8 illustrates the processing performed in step S605 in FIG. 6 in detail. An active stream in the present exemplary embodiment is a stream that has been established between the communication apparatuses 10 and 20.

In step S801, the communication determination unit 310 acquires a stream ID having the largest value (the latest stream ID) among the stream IDs of the established or reserved streams that are managed by the HTTP control unit 307. In step S802, the communication determination unit 310 sequentially determines the established or reserved streams managed by the HTTP control unit 307 to be determination target streams, starting from the stream whose ID is 1. In addition, the communication determination unit 310 acquires information about the acquired stream. In step S803, by referring to the information about the stream acquired in step S802, the communication determination unit 310 determines whether this target stream is a stream that has caused a stream error. If the target stream is a stream that has caused a stream error (Yes in step S803), the processing returns to step S802. Then, the communication determination unit 310 determines a stream having the next ID to be the target stream, and acquires information about the target stream. On the other hand, if the target stream is not a stream that has caused a stream error (No in step S803), the processing proceeds to step S804.

In step S804, the communication determination unit 310 determines whether the status of the target stream is open or half-closed. If the status of the target stream is open or half-closed (Yes in step S804), the processing proceeds to step S805. If the status of the target stream is neither open nor half-closed (No in step S805), the processing proceeds to step S806. In HTTP/2, if the status of a stream transmitted between communication apparatuses is open or half-closed, the stream has already been established. Namely, at least one of the communication apparatuses is transmitting data or ready to transmit data.

In step S805, the communication determination unit 310 determines that there are active and valid streams other than the stream that has caused the latest stream error, and ends the processing in FIG. 8. Then, the processing proceeds to step S609 in FIG. 6. In step S806, the communication determination unit 310 determines whether the target stream ID matches the latest stream ID. If the target stream ID matches the latest stream ID (Yes in step S806), the processing proceeds to step S807. If not (No in step S806), the processing returns to step S802, and the communication determination unit 310 determines a stream having the next ID to be the target stream to acquire information about the target stream. In step S807, the communication determination unit 310 determines that there are not any active and valid streams other than the stream that has caused the stream error and ends the processing in FIG. 8. Then, the processing proceeds to step S606 in FIG. 6.

As described above, if the communication apparatus 20 according to the present exemplary embodiment detects a stream error when communicating with the communication apparatus 10, the communication apparatus 20 handles the stream error as a connection error and terminates the connection depending on the cause of the stream error and the number of detected stream errors. In this way, the communication apparatus 20 can suppress the increase of the processing load caused by handling of the stream error.

For example, the present invention assumes that the communication apparatus 20 cannot accept any new streams because its communication resources are continuously insufficient. If the technique described in the present exemplary embodiment is not applied, the communication apparatus 20 repeatedly handles the stream errors caused by requests for establishing new streams (HEADERS frames) transmitted from the communication apparatus 10, while maintaining the corresponding connection. As a result, the communication apparatus 20 continues to consume its resources. In contrast, if the technique described in the present exemplary embodiment is applied, by terminating the connection, the communication apparatus 20 can avoid unnecessarily consuming its resources on handling of such repeatedly caused stream errors. Further, if there is another request, to which the communication apparatus 20 has not been able to respond due to the limited number of connections that the communication apparatus 20 can simultaneously establish, the communication apparatus 20 can establish a new connection to be used for responding to the request by terminating the connection. Furthermore, when the communication apparatus 20 detects a stream error and terminates the corresponding connection, the communication apparatus 20 may instruct the communication apparatus 10 not to use a communication parameter that may cause the same type of stream errors.

If each stream error is handled as a connection error, it is likely that the communication apparatus 20 terminates more connections. As a result, overhead needed for reconnecting HTTP communications is increased, and the overall performance of the system is degraded. In contrast, according to the present exemplary embodiment, since a connection error is determined on the basis of the cause of a stream error and the number of detected stream errors, the excessive overhead needed for reconnecting HTTP communications can be avoided.

The communication apparatus 20 according to the present exemplary embodiment determines whether to handle a stream error as a connection error on the basis of the communication status at the time of occurrence of the stream error. For example, in order to determine whether to handle a stream error as a connection error, the connection determination unit 308 determines whether there are any active and valid streams other than the stream that has caused the stream error. If there are other active and valid streams, the communication apparatus 20 does not handle the stream error as a connection error. In this way, the communications being performed based on the other active streams are not halted by the termination of the connection. As a result, the overall performance of the system is improved.

There is a case in which the overall performance of the system is improved by terminating a connection and resuming the corresponding communication with a new connection, even if the communications based on the other active streams are halted. Therefore, when determining whether to handle a stream error as a connection error, the connection determination unit 308 may determine whether the number of active streams other than the stream that has caused the stream error is less than a predetermined number. More specifically, when the stream determination unit 309 detects a stream that has caused a stream error, the connection determination unit 308 determines whether the number of streams established based on the corresponding connection is less than a predetermined number. If the number is less than the predetermined number, the connection determination unit 308 determines whether to handle the stream error as a connection error, for example, on the basis of the number of errors detected by the stream determination unit 309 or the content of the data processed by the HTTP control unit 307. If the above number of streams is equal to or more than the predetermined number, the connection determination unit 308 determines not to handle the stream error as a connection error.

In addition, the connection determination unit 308 may determine whether to handle a stream error as a connection error on the basis of the content of the data transmitted by the HTTP control unit 307 using the stream. More specifically, if the stream determination unit 309 detects a stream that has caused a stream error, the connection determination unit 308 determines whether the HTTP control unit 307 uses the stream corresponding to the stream error for transmitting a moving image or a still image of a predetermined display size or larger. If the stream is used to transmit a moving image or a still image of the predetermined size or larger, the connection determination unit 308 determines whether to handle the stream error as a connection error on the basis of the number of detected errors, the number of streams based on the corresponding connection, or the like. For example, when a stream that has caused a stream error is detected and the stream is used for transmitting a moving image or still image of the predetermined display size or larger, if the number of stream errors detected by the stream determination unit 309 is equal to or more than a threshold, the connection determination unit 308 handles the stream error as a connection error. If the stream corresponding to the stream error is used for transmitting a moving image or still image that is less than the predetermined display size, the connection determination unit 308 determines not to handle the stream error as a connection error. In this way, if a stream error is caused by transmission of an auxiliary content whose display size is small, the communication apparatus 20 does not terminate the connection. Namely, transmission of a main content whose display size is large is not halted by termination of the connection.

If the communication apparatus 20 according to the present exemplary embodiment detects at least a predetermined number of errors caused by streams (second logical streams) based on a single connection (a first logical connection) among a plurality of connections that can be established within a predetermined period of time, the communication apparatus 20 terminates the connection. The above predetermined period of time is, for example, a period from the establishment to the termination of a single connection. However, the period may be shorter than the above period. By shortening the above predetermined period, when stream errors intensively occur only in a certain period, the HTTP control unit 307 terminates the connection. Thus, unnecessary consumption of the resources can be avoided.

The stream determination unit 309 may count errors other than the stream errors based on a single connection. For example, there is a case in which a plurality of connections are established between the communication apparatuses 20 and 10. In such a case, if the total number of stream errors detected in the connections reaches a predetermined number or more, the communication apparatus 20 may terminate the connections.

The connection determination unit 308 may change the threshold set for the number of stream error detection for the connection error determination processing, depending on the cause of the error detected by the stream determination unit 309. For example, the connection determination unit 308 may set a larger threshold for an error cause that can frequently occur, such as for a failure of accepting a HEADERS frame or a PUSH_PROMISE frame. In contrast, the connection determination unit 308 may set a smaller threshold for a stream error cause that occurs less frequently but has a significant impact on the communication, such as for a failure of accepting a WINDOW_UPDATE frame. In this way, the trade-off between the consumption of the resources for continuing the communication and the overhead for reconnecting the HTTP communication can be controlled in more detail. As a result, the overall performance of the system can be improved.

Likewise, the connection determination unit 308 may change the threshold, depending on the resource status of the communication apparatus 20. For example, if the communication apparatus 20 has a predetermined amount or more of available memory, which is one of the resources thereof, the connection determination unit 308 sets a larger threshold. If not, the connection determination unit 308 sets a smaller threshold. This is because, if the available memory is small, even if the communication apparatus 20 continues the communication, there is a high possibility that stream errors repeatedly occur. Therefore, terminating the connection is more efficient. In this way, the above trade-off can be controlled in more detail, and the overall performance of the system can be improved further.

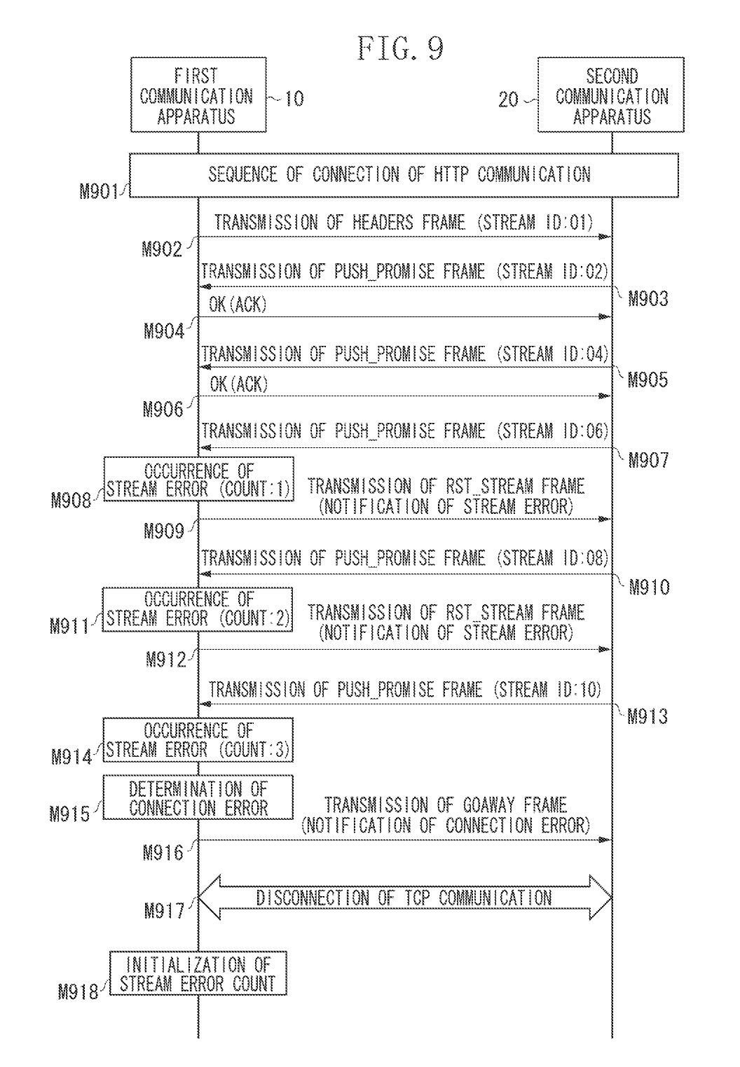

The stream determination unit 309 according to the present exemplary embodiment counts the number of detected stream errors depending on the cause of the stream error. For example, if a predetermined number of or more errors regarding the number of streams based on a connection are detected within a predetermined period of time, the communication apparatus 20 may terminate the connection. The error regarding the number of streams based on a connection is, for example, a stream error that occurs when the communication apparatus 10 requests the communication apparatus 20 to establish or reserve more streams than the communication apparatus 20 can accommodate, as described above with FIG. 4 or as will be described below with FIG. 9. Further, the stream determination unit 309 may count the number of detected stream errors depending on the content of a request received by the communication apparatus 20. In this way, the communication apparatus 20 can determine whether to handle a stream error as a connection error depending on the content of a service to provide. As a result, the overall performance of the system can be further improved.

The stream determination unit 309 according to the present exemplary embodiment initializes the number of stream error detection count after the HTTP communication is disconnected. However, after the disconnection of the HTTP communication, the stream determination unit 309 may hold the number of stream error detection count for a predetermined period of time before initializing the count. In this case, if the communication apparatus 10 starts a new HTTP communication and if a first stream error occurs within the above predetermined period of time, the HTTP communication is disconnected. In this way, for example, when the communication apparatus 10 starts an HTTP communication again, even if a stream error occurs due to the same cause, the same situation is not repeated.

After the HTTP control unit 307 terminates a connection (a first logical connection) with the communication apparatus 10, if the communication apparatus 10 requests the communication apparatus 20 to start a new connection, the TCP control unit 306 may reject the connection request. The TCP control unit 306 may reject the request by notifying the communication apparatus 10 of a connection error or by not responding to the request, namely, by ignoring the request. Alternatively, a different method may be used. In this way, the communication apparatus 20 less performs unnecessary processing, compared with a case where the communication apparatus 20 restarts a connection, determines a connection error, and terminates the connection. In addition, depending on the implementation, a connection request may be rejected by hardware processing. With this implementation, if the communication apparatus 10 repeats connection requests, the connection requests are rejected. Namely, compared with a case where the communication apparatus 20 maintains a connection and continues to reject the stream requests, this implementation can maintain the amount of resource consumption at a low level.

The stream determination unit 309 may count the number of stream error detection count upon receiving a request that causes a stream error, and initialize the number of stream error detection count upon receiving a normal request that does not cause a stream error. Using this method, for example, the steam determination unit 309 can distinguish between malicious communication apparatuses attacking by intentionally creating stream errors and normal communication apparatuses, and can respond accordingly. As a result, the trade-off between the overall performance of the system and the security of the system can be controlled. In addition, the stream determination unit 309 may initialize the number of stream error detection count after a predetermined period of time after receiving a normal request that does not cause a stream error. In this way, the stream determination unit 309 can also address malicious communication apparatuses that transmit normal requests regularly.

In addition, if the stream determination unit 309 determines that the communication apparatus 20 has been attacked by a malicious communication apparatus, the stream determination unit 309 may register information about this malicious communication apparatus, such as an IP address thereof, in a black list. In this case, the number of stream error detection count that corresponds to the malicious communication apparatus does not need to be initialized.

Before determining a stream error as a connection error in step S606 in FIG. 6, the connection determination unit 308 may check with a user of the communication apparatus 20 if the stream error needs to be handled as a connection error. For example, before determining the stream error as a connection error, the connection determination unit 308 uses the display control unit 303 to display a message that asks the user if the stream error needs to be handled as a connection error. Then, the connection determination unit 308 uses the operation control unit 304 to acquire an instruction input by the user of the communication apparatus 20 about the error. If the instruction from the user is to handle the stream error as a connection error, the connection determination unit 308 determines to handle the stream error as a connection error in step S606. If not, the connection determination unit 308 determines not to handle the stream error as a connection error in step S609. In this way, since a connection error is not determined against the intention of the user, the user-friendliness is improved.

Now, a second exemplary embodiment according to the present invention will be described. Regarding the configuration of the communication system, the configuration of function modules, the sequences, and the flowcharts according to the second exemplary embodiment, the same elements between the first and second exemplary embodiments will not be described. In the present exemplary embodiment, the communication apparatus 10 includes the function modules illustrated in FIG. 3 and performs the connection error determination processing according to the flowchart illustrated in FIG. 6.

FIG. 9 is a sequence diagram illustrating processing performed by the communication apparatuses 10 and 20 from a start to an end of an HTTP communication according to the second exemplary embodiment. The processing in FIG. 9 starts when a user inputs an instruction for acquiring a content from the communication apparatus 20 to the communication apparatus 10. However, the processing in FIG. 9 may start at a different timing. In FIG. 9, description of the same portions as those in FIG. 4 will be omitted.

In M901, the communication apparatus 10 establishes connection of an HTTP communication with the communication apparatus 20. In M902, the communication apparatus 10 transmits a HEADERS frame in which HTTP request header information is written to the communication apparatus 20. By transmitting the HEADERS frame, the communication apparatus 10 requests the communication apparatus 20 to establish a new stream whose stream ID is 1.

In M903, the communication apparatus 20 transmits a PUSH_PROMISE frame as a response to the HEADERS frame received in M902 and requests the communication apparatus 10 to reserve a stream for server push. An ID of the reserved stream requested in M903 is 2. In M904, the communication apparatus 10 transmits a TCP ACK as a response to the PUSH_PROMISE frame received in M903.

In M905, as in M903, the communication apparatus 20 transmits a PUSH_PROMISE frame as a response to the HEADERS frame received in M902. An ID of the reserved stream requested in M905 is 4. In M906, as in M904, the communication apparatus 10 transmits a TCP ACK as a response to the PUSH_PROMISE frame received in M905. In M907, as in M903, the communication apparatus 20 transmits a PUSH_PROMISE frame as a response to the HEADERS frame received in M902. An ID of the reserved stream requested in M907 is 6.

In M908, the communication apparatus 10 fails to accept the request for reserving a new stream due to its insufficient memory resources or the like, and a stream error occurs. In M908, the stream determination unit 309 in the communication apparatus 10 detects the stream error and increments the number of detected stream errors by 1 (count: 1). In the present exemplary embodiment, if the stream determination unit 309 detects three or more stream errors that have occurred due to the same cause, the connection determination unit 308 of the communication apparatus 10 determines to handle the corresponding stream error as a connection error. In M909, the HTTP control unit 307 in the communication apparatus 10 transmits a RST_STREAM frame that indicates the stream error to the communication apparatus 20.

In M910, as in M903, the communication apparatus 20 transmits a PUSH_PROMISE frame as a response to the HEADERS frame received in M902. An ID of the reserved stream requested in M910 is 8. In M911, a stream error occurs due to the same cause as that in M908. In M911, as in M908, the stream determination unit 309 in the communication apparatus 10 detects the stream error and increments the number of detected stream errors by 1 (count: 2). In M912, as in M909, the HTTP control unit 307 in the communication apparatus 10 transmits a RST_STREAM frame to the communication apparatus 20. In M913, as in M903, the communication apparatus 20 transmits a PUSH_PROMISE frame as a response to the HEADERS frame received in M902. An ID of the reserved stream requested in M913 is 10.

In M914, a stream error occurs due to the same cause as that in M908. In M914, as in M908, the stream determination unit 309 in the communication apparatus 10 detects the stream error and increments the number of detected stream errors by 1 (count: 3). In M915, the number of detected stream errors that have occurred due to the same cause has reached 3. In addition, since there are not any other active streams, the connection determination unit 308 in the communication apparatus 10 determines to handle the stream error as a connection error. In M916, the HTTP control unit 307 in the communication apparatus 10 transmits a GOAWAY frame that indicates the connection error to the communication apparatus 20. In M917, the communication apparatuses 10 and 20 terminate the HTTP communication. In M918, the stream determination unit 309 in the communication apparatus 10 initializes the number of stream error detection count (count: 0).

As described above, when the communication apparatus 10 according to the present exemplary embodiment receives a request for reserving a stream from the communication apparatus 20 and a stream error occurs, the communication apparatus 10 refers to the cause of the stream error and the number of stream errors that have occurred. Depending on these statuses, the communication apparatus 10 handles the stream error as a connection error and terminates the connection. In this way, the communication apparatus 10 does not need to individually handle stream-reservation requests more than the communication apparatus 10 can accommodate. As a result, unnecessary consumption of the resources can be reduced.

The present exemplary embodiment has been described assuming a case where the communication apparatus 10 fails to accept a request for reserving a stream due to its insufficient memory resources or the like, and a stream error occurs. However, a stream error may occur when the communication apparatus 10 receives stream-reservation requests more than a predetermined number (second predetermined number) of stream-reservation requests. For example, the communication apparatus 10 may preset the number of stream reservations that the communication apparatus 10 can accept. In this case, the preset number of stream reservations serves as the second predetermined number.

In the first exemplary embodiment, the communication apparatus 20 includes functions of detecting and counting stream errors, determining a connection error, and terminating the connection. In the second exemplary embodiment, the communication apparatus 10 includes the equivalent functions. However, the present invention is not limited to these examples. The advantageous same effects are achieved even when a proxy server or the like that relays a communication between the communication apparatuses 10 and 20 includes the above functions.

According to the above exemplary embodiments, a first logical connection is terminated depending on a status of a detected error caused by a second logical connection. Thus, it is possible to suppress the increase of the processing load placed on a communication apparatus, the processing load required by handling of the error caused by the second connection established based on the corresponding first connection.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-105893, filed May 25, 2015, which is hereby incorporated by reference herein in its entirety.

What is claimed is:

1. A communication apparatus comprising:
a communication unit configured to perform a communication with a different communication apparatus using one or more second logical connections established based on a first logical connection established between the communication apparatus and the different communication apparatus;
a detection unit configured to detect an error caused by a second logical connection used by the communication unit on the basis of a content of data that the communication unit has received when communicating with the different communication apparatus; and
a termination unit configured to terminate, if the detection unit detects an error caused by the second logical connection, the first logical connection on the basis of a communication status between the communication apparatus and the different communication apparatus.

2. The communication apparatus according to claim 1, wherein the communication status between the communication apparatus and the different communication apparatus includes at least one of the number of errors detected by the detection unit, the number of second logical connections based on the first logical connection, and a content of data transmitted by the communication unit using the second logical connection.

3. The communication apparatus according to claim 1, further comprising a rejection unit configured to reject a request for a new first logical connection, the request being transmitted from the different communication apparatus to the communication apparatus after the termination unit terminates the first logical connection.

4. The communication apparatus according to claim 1, wherein, if the detection unit detects a predetermined number of one or more errors caused by the second logical connections based on the first logical connection within a predetermined period of time, the termination unit terminates the first logical connection.

5. The communication apparatus according to claim 1, wherein, if the detection unit detects a predetermined number of or more errors regarding the number of second logical connections based on the first logical connection within a predetermined period of time, the termination unit terminates the first logical connection.

6. The communication apparatus according to claim 5, wherein, if the communication apparatus is requested by the different communication apparatus to establish more than a first predetermined number of second logical connections, an error regarding the number of second logical connections based on the first logical connection occurs.

7. The communication apparatus according to claim 5, wherein, if the communication apparatus is requested by the different communication apparatus to reserve more than a second predetermined number of second logical connections, an error regarding the number of second logical connections based on the first logical connection occurs.

8. The communication apparatus according to claim 1,
wherein, when the detection unit has detected an error caused by the second logical connection, if the number of second logical connections established based on the first logical connection is less than a predetermined number, the termination unit terminates the first logical connection on the basis of at least one of the number of errors detected by the detection unit and a content of data that the communication unit transmits using a second logical connection, and
wherein, when the detection unit has detected an error caused by the second logical connection, if the number of second logical connections established based on the first logical connection is equal to or more than the predetermined number, the termination unit does not terminate the first logical connection.

9. The communication apparatus according to claim 1,
wherein, when the detection unit has detected an error caused by the second logical connection, if the second logical connection corresponding to the error is the one used by the communication unit to transmit a moving image or a still image whose display size is equal to or more than a predetermined size, the termination unit terminates the first logical connection on the basis of at least one of the number of errors detected by the detection unit and the number of second logical connections based on the first logical connection, and
wherein, when the detection unit has detected an error caused by the second logical connection, if the second logical connection corresponding to the error is the one used by the communication unit to transmit a moving image or a still image whose display size is less than the predetermined size, the termination unit does not terminate the first logical connection.

10. The communication apparatus according to claim 3, wherein the rejection unit rejects the request by notifying the different communication apparatus, which has requested the new first logical connection, of an error, or by not responding to the request.

11. The communication apparatus according to claim 1, wherein the first logical connection and the one or more second logical connections are a connection and one or more streams defined in HTTP/2, respectively.

12. The communication apparatus according to claim 1, wherein the termination unit terminates the first logical connection by transmitting a GOAWAY frame defined in HTTP/2 to the different communication apparatus and/or disconnecting the first logical connection.

13. A communication method used for a communication between a plurality of communication apparatuses, the communication method comprising:
performing a communication using one or more second logical connections established based on a first logical connection established between the plurality of communication apparatuses;
detecting an error caused by a second logical connection used in the communication on the basis of a content of data transmitted in the communication; and
terminating the first logical connection on the basis of a communication status between the plurality of communication apparatuses if an error is detected in the detecting.

14. The communication method according to claim 13, wherein the communication status between the plurality of communication apparatuses includes at least one of the number of errors detected in the detecting, the number of second logical connections based on the first logical connection, and a content of data transmitted using the second logical connection in the communicating.

15. The communication method according to claim 13, further comprising rejecting a request for a new first logical connection between the plurality of communication apparatuses after the first logical connection is terminated in the terminating.

16. The communication method according to claim 13, wherein, if a predetermined number of or more errors regarding the number of second logical connections based on the first logical connection is detected within a predetermined period of time in the detecting, the first logical connection is terminated in the terminating.

17. A non-transitory storage medium storing a program executable by a computer used as a communication apparatus, the program comprising:
performing a communication with a different communication apparatus using one or more second logical connections established based on a first logical connection established between the communication apparatus and the different communication apparatus;
detecting an error caused by a second logical connection used in the communication on the basis of a content of data that the communication apparatus has received when communicating with the different communication apparatus in the communication; and
terminating, if an error caused by the second logical connection is detected in the detecting, the first logical connection on the basis of a communication status between the communication apparatus and the different communication apparatus.
